(19) United States
(12) Patent Application Publication
(10) Pub. No.: US 2019/0171141 A1
(43) Pub. Date: Jun. 6, 2019

(54) FIXING DEVICE AND IMAGE FORMING DEVICE

(71) Applicant: KONICA MINOLTA, INC., Tokyo (JP)

(72) Inventors: Makoto FUJII, Tokyo (JP); Yasuo SHIRODAI, Tokyo (JP)

(21) Appl. No.: 16/209,127

(22) Filed: Dec. 4, 2018

(30) Foreign Application Priority Data
Dec. 6, 2017 (JP) 2017-234304

(51) Int. Cl. G03G 15/20; G03G 15/00

(52) U.S. Cl. CPC G03G 15/2053; G03G 15/6585; G03G 15/2028

(57) ABSTRACT

A fixing device fixes a toner image formed on a paper sheet, and the fixing device includes: an endless fixing belt; a pressure roller that is rotatable; and a pressing member that is arranged to face the pressure roller with the fixing belt interposed there between and forms a fixing nip for conveying a paper sheet between the pressing member and the pressure roller, wherein a toner layer of the toner image includes crystalline polyester resin, and a pressure distribution of the fixing nip in a sheet passing direction is set so that pressure at an inlet side in the sheet passing direction is the largest, and gloss of an image fixed on the paper sheet is enhanced.

### CROSS-REFERENCE TO RELATED APPLICATION(S)

The present application claims priority under 35 U.S.C § 119(e) to Japanese patent Application No. 2017-234304, filed on Dec. 6, 2017, is incorporated herein by reference in its entirety.

### BACKGROUND

### Technological Field

The present invention relates to a fixing device and an image forming device.

### Description of the Related Art

In recent years, in view of protection of global environment, energy saving of an image forming device has been actively facilitated. The image forming device includes a fixing device for fixing a toner image on a paper sheet incorporated therein. The fixing device includes a heating source to heat and melt a toner layer formed on the paper sheet when performing fixing processing on the paper sheet, and consumes large power. Therefore, it has been desired to increase thermal energy efficiency.

As the fixing device, for example, a heat-roller-type fixing device has been conventionally known in general. In the heat-roller-type fixing device, a heating roller which includes the heating source therein and a pressure roller which is provided as facing the heating roller and presses the heating roller form a fixing nip. However, in the heat-roller-type fixing device, thermal capacities of the heating roller and the pressure roller are large. Therefore, the heat-roller-type fixing device has disadvantages such that it takes time to increase the temperature of the fixing nip to a temperature suitable for fixing the toner image and the power consumption increases.

In connection with this, to cope with the disadvantages of the heat-roller-type, a belt-nip-type and a film-heating-type fixing devices have been proposed. In the belt-nip-type fixing device, by pressing a pressure member provided on an inner side of an endless belt relative to the heating roller, a fixing nip is formed between the belt and the heating roller (for example, refer to JP 2007-328046 A). In JP 2007-328046 A, by using the pressure member and the belt having small thermal capacities, the time until the temperature of the fixing nip reaches the temperature suitable for fixing the toner image can be shortened as compared with the heat-roller-type fixing device.

In the film-heating-type, by pressing a pressure pad provided on an inner side of a fixing film relative to the pressure roller, a fixing nip is formed between the fixing film and the pressure roller (for example, refer to JP 2010-54526 A). In JP 2010-54526 A, by using the pressure pad and the fixing film having small thermal capacities, the time until the temperature of the fixing nip reaches the temperature suitable for fixing the toner image can be shortened as compared with the heat-roller-type fixing device.

However, in a case where heat is supplied to the pressure member or the pressure pad having the small thermal capacity, since the pressure member or the pressure pad cannot sufficiently store heat, there is a possibility that heat cannot be sufficiently supplied to the toner layer on the paper sheet. Furthermore, as a speed of the fixing processing becomes faster, thermal energy necessary for a unit time increases. Therefore, there is a possibility that heat is not sufficiently supplied to the toner layer. In a case where heat is not sufficiently supplied to the toner layer, toner particles on the toner surface layer do not sufficiently melt, and there is a possibility that the toner surface layer is not smoothed. As a result, there is a problem in that the fixed image does not sufficiently have gloss.

In addition, in a case where a paper sheet with high glossiness such as gloss coated paper is used, if gloss of the image fixed on the paper sheet is low, a difference between gloss of the image and gloss of the paper sheet around the image increases. As a result, there is a problem in that the image seems to be floating up or sinking, resulting in an unnatural image.

### SUMMARY

The present invention has been made in view of the above problems. Therefore, an object of the present invention is to provide a fixing device and an image forming device capable of fixing a toner image so that the fixed image sufficiently has gloss.

To achieve the abovementioned object, according to an aspect of the present invention, there is provided a fixing device that fixes a toner image formed on a paper sheet, and the fixing device reflecting one aspect of the present invention comprises: an endless fixing belt; a pressure roller that is rotatable; and a pressing member that is arranged to face the pressure roller with the fixing belt interposed therebetween and forms a fixing nip for conveying a paper sheet between the pressing member and the pressure roller, wherein a toner layer of the toner image includes crystalline polyester resin, and a pressure distribution of the fixing nip in a sheet passing direction is set so that pressure at an inlet side in the sheet passing direction is the largest, and gloss of an image fixed on the paper sheet is enhanced.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is schematic cross-sectional view of an example of a configuration of an image forming system according to an embodiment;

FIG. 2 is a block diagram of a hardware configuration of the image forming device illustrated in FIG. 1;

FIG. 3 is a diagram of a schematic configuration of a fixer illustrated in FIG. 1;

FIG. 4 is a graph of a temperature change of a fixing belt in a sheet passing direction of a fixing nip and a temperature change of a toner layer in the sheet passing direction of a paper sheet passed through the fixing nip in the embodiment;

FIG. 5 is a schematic diagram of a modeled melted state of the toner layer accompanied by heat and pressure according to the embodiment;

FIG. 6 is a schematic diagram of an example of a case where a position of pressure roller relative to a pad in sheet passing direction is changed;

FIG. 7 is a diagram of temperature characteristics of storage elastic modulus of a toner used in the embodiment and a conventional toner (comparative example);

FIG. 8 is a schematic diagram of a modification of the fixing device according to the embodiment;

FIG. 9 is a graph of an example of conditions of a pressure distribution with respect to the pad;

FIG. 10 is a graph of results of a comparative experiment (system speed: 415 mm/s) for exemplifying a difference in glossiness due to a difference in a position to which pressure is applied; and

FIG. 11 is a graph of results of a comparative experiment (system speed: 300 mm/s) for exemplifying a difference in glossiness due to a difference in a position to which pressure is applied.

### DETAILED DESCRIPTION OF EMBODIMENTS

Hereinafter, one or more embodiments of a fixing device and an image forming device according to the present invention will be described with reference to the accompanying drawings. However, the scope of the invention is not limited to the disclosed embodiments. In the drawings, the same reference numerals are used for the same members. Furthermore, dimensional ratios of the drawings are exaggerated for convenience of description, and may be different from an actual ratio.

### EMBODIMENT

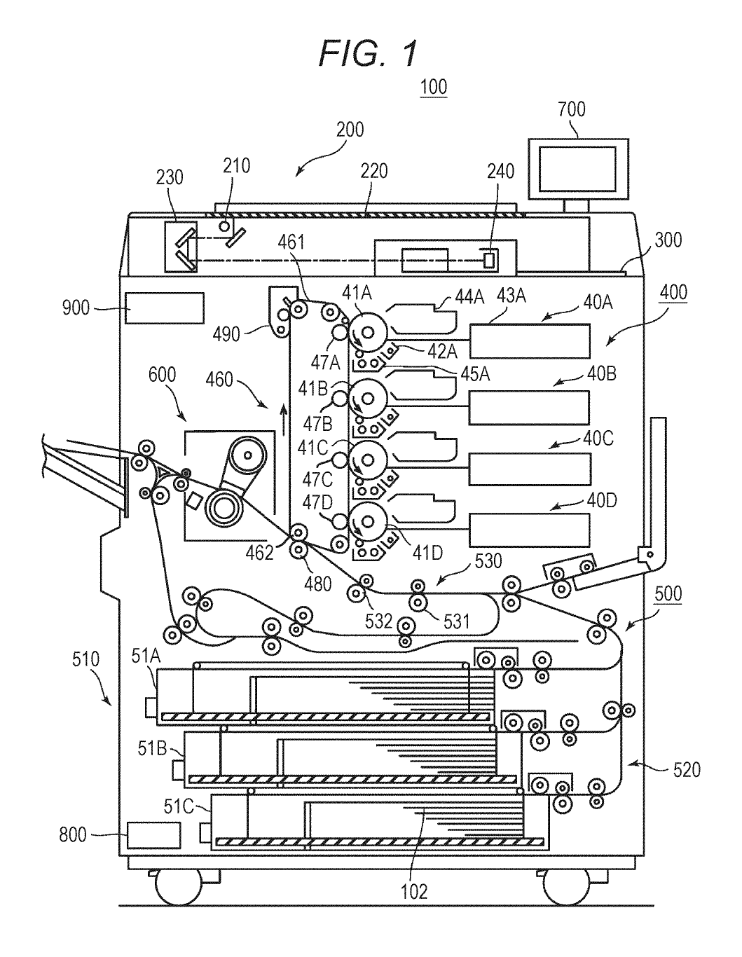

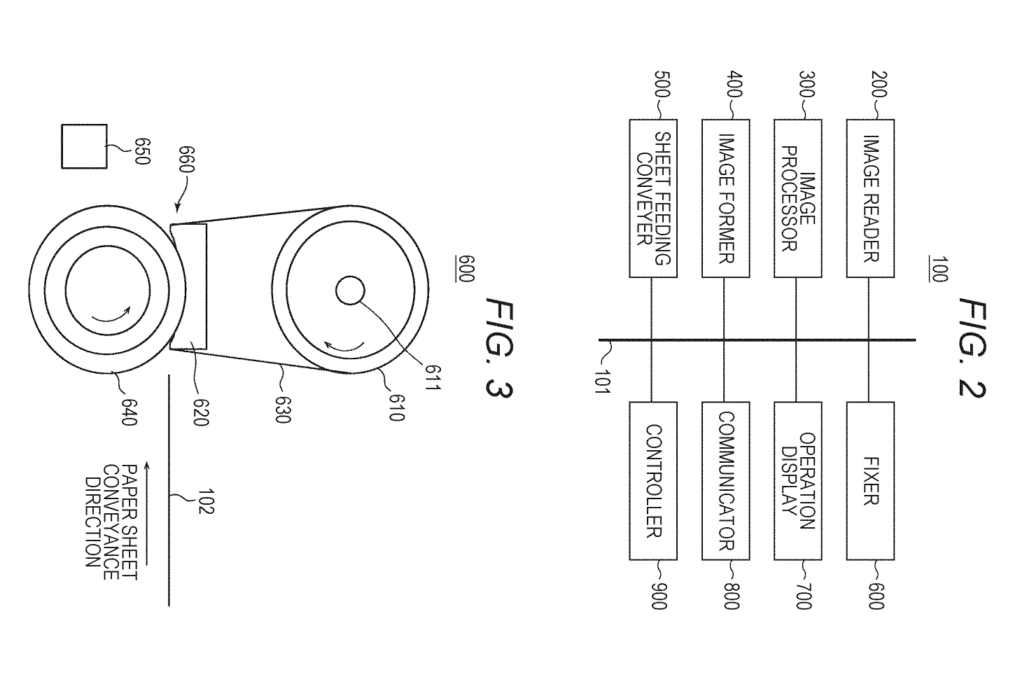

FIG. 1 is a diagram of a schematic configuration of an image forming device 100 according to an embodiment, and FIG. 2 is a block diagram of a hardware configuration of the image forming device 100 illustrated in FIG. 1. FIG. 3 is a diagram of a schematic configuration of a fixer 600 illustrated in FIG. 1.

<Image Forming Device 100>

As illustrated in FIG. 1 and FIG. 2, the image forming device 100 according to the present embodiment includes an image reader 200, an image processor 300, an image former 400, a sheet feeding conveyer 500, the fixer 600, an operation display 700, a communicator 800, and a controller 900.

The image forming device 100 is an electrophotographic image forming device and is a so-called tandem type color image forming device which forms a color image by arranging a plurality of photosensitive drums to face an intermediate transfer belt. In the present embodiment, an example will be described in a case where the image forming device 100 is a multifunction peripheral (MFP). However, the image forming device 100 may be a copier, a facsimile, a printer, and the like.

Components including the image reader 200, the image processor 300, the image former 400, the sheet feeding conveyer 500, the fixer 600, the operation display 700, the communicator 800, and the controller 900 are communicably connected to each other with an internal bus 101. The components will be described in order below.

The image reader 200 includes an image pickup device, reads an image of a document, and generates an image data signal.

The image processor 300 performs various image processing on the image data signal received from the image reader 200 and generates print image data. The generated print image data is transmitted to the image former 400.

<Image Former 400>

The image former 400 electrophotographically forms an image. The image former 400 includes an image former 40A for forming a yellow (Y) image, an image former 40B for forming a magenta (M) image, an image former 40C for forming a cyan (C) image, an image former 40D for forming a black (K) image, and a transfer unit 460.

The image former 40A includes a photosensitive drum 41A as an image carrier, and a charger 42A, an optical writer 43A, a developer device 44A, and a drum cleaner 45A arranged around the photosensitive drum 41A.

The photosensitive drum 41A is rotated at a predetermined speed by a drum motor which is not illustrated. The charger 42A includes a corona discharge electrode arranged around the photosensitive drum 41A and charges a surface of the photosensitive drum 41A with generated ions. The optical writer 43A includes a scanning optical device incorporated therein, exposes the charged photosensitive drum 41A based on the input print image data to deteriorate a potential of the exposed part, and forms a charge pattern (electrostatic latent image) corresponding to the print image data.

The developer device 44A develops the formed electrostatic latent image and visualizes the developed image by toner. After a toner image has been transferred on an intermediate transfer belt 461 to be described later, the drum cleaner 45A scrapes (remove) residues such as toner and external additives remaining on the surface of the photosensitive drum 41A so as to maintain an excellent surface state.

The image former 40A having such a configuration receives the print image data generated by the image processor 300, writes the print image data on the photosensitive drum 41A by the optical writer 43A, and forms a latent image based on the print image data on the photosensitive drum 41A. Then, the latent image is developed by the developer device 44A, and a toner image which is a visible image is formed on the photosensitive drum 41A.

Each of the image formers 40B, 40C, and 40D has a photosensitive drum, a charger, an optical writer, a developer device, and a drum cleaner having similar configurations to those in the image former 40A. Therefore, on the photosensitive drums 41A, 41B, 41C, and 41D of the image former 400, a yellow (Y) image, a magenta (M) image, a cyan (C) image, and a black (K) image are respectively formed. Regarding the structures of the photosensitive drums, the chargers, the optical writers, the developer devices, and the drum cleaners of the image formers 40B, 40C, and 40D are the same as those of components of the image former 40A, except for colors of toners of developers stored in the developers. Therefore, detailed description thereof will be omitted.

Hereinafter, in the description on the components which are commonly used in the image formers 40A, 40B, 40C, and 40D, the components are expressed as the image former 400, a photosensitive drum 410, a charger 420, an optical writer 430, a developer device 440, and a drum cleaner 450.

The transfer unit 460 includes the intermediate transfer belt 461, a driving roller 462, primary transfer rollers 47A to 47D, a secondary transfer roller 480, and an intermediate transfer belt cleaner 490. The intermediate transfer belt 461 is wound around a plurality of rollers including the driving roller 462 and a steering roller and is supported so as to be able to travel.

The driving roller 462 is driven by a driving motor which is not illustrated and rotates the intermediate transfer belt 461. The toner images of the respective colors on the photosensitive drums 41A to 41D are sequentially transferred on the intermediate transfer belt 461 for traveling by the primary transfer rollers 47A to 47D, and a color image in which color layers of yellow (Y), magenta (M), cyan (C), and black (K) are superimposed is formed. The color image on the intermediate transfer belt 461 is transferred on a paper sheet 102, which is conveyed by the sheet feeding conveyer 500, by the secondary transfer roller 480. Furthermore, the intermediate transfer belt cleaner 490 removes the toner remaining on the intermediate transfer belt 461.

<Sheet Feeding Conveyer 500>

The sheet feeding conveyer 500 conveys a paper sheet in the image forming device 100. The sheet feeding conveyer 500 includes a sheet feeder 510, a paper sheet conveyance path 520, and a plurality of conveyance rollers 530.

The sheet feeder 510 includes a plurality of sheet feeding trays 51A to 51C for housing the paper sheets 102. The plurality of conveyance rollers 530 includes a loop roller 531 and a resist roller 532.

The paper sheets 102 housed in any one of sheet feeding trays 51A to 51C are fed to the paper sheet conveyance path 520 one by one. The paper sheet 102 is conveyed along the paper sheet conveyance path 520 by the plurality of conveyance rollers 530. The paper sheet 102 is conveyed to the secondary transfer roller 480 via the loop roller 531 and the resist roller 532. The paper sheet 102 on which the toner image is transferred by the secondary transfer roller 480 is conveyed to the fixer 600.

<Fixer 600>

The fixer 600 functions as a fixing device and fixes the toner image formed on the paper sheet 102. As illustrated in FIG. 3, the fixer 600 includes a heating roller 610, a pad 620, a fixing belt 630, a pressure roller 640, and a pressure adjuster 650.

The heating roller 610 includes, in order from the inner side, a core metal formed of cylindrical metal, an elastic layer which is formed on the surface of the core metal and is formed of a material such as silicone rubber, foamed silicone rubber, and the like, and a release layer such as fluororesin, and the heating roller 610 is rotatably supported. The heating roller 610 includes a heater lamp 611 as a heating source, and the heater lamp 611 is, for example, a halogen lamp and heats the fixing belt 630. The heat of the fixing belt 630 is transmitted to the pad 620 by rotation of the fixing belt 630.

The pad 620 functions as a pressing member and receives a pressing force from the pressure roller 640. The pad 620 is pressed by the pressure roller 640 having the fixing belt 630 interposed therebetween so as to form a fixing nip 660 between the fixing belt 630 and the pressure roller 640.

One side of the pad 620 facing the pressure roller 640 may have a shape matching a curvature of the pressure roller 640. Accordingly, the paper sheet 102 can be uniformly pressed by the fixing nip 660.

The pad 620 may be formed of, for example, a resin material having heat resistance and a rubber material such as fluororubber and silicone rubber. Furthermore, the surface of the pad 620 may be covered with fluororesin and the like to reduce a sliding resistance with the fixing belt 630.

The fixing belt 630 is an endless belt formed of, for example, a resin material such as polyimide and is stretched around the heating roller 610 and the pad 620. The heater lamp 611 supplies heat to the fixing belt 630, and the fixing belt 630 plays a role of transmitting the heat to the pad 620. Furthermore, a surface of the fixing belt 630 having contact with the pad 620 may be coated with lubricant such as grease to reduce a frictional force between the fixing belt 630 and the pad 620.

The pressure roller 640 includes, in order from the inner side, a core metal formed of cylindrical metal, an elastic layer which is formed on the surface of the core metal and is formed of a material such as silicone rubber, foamed silicone rubber, and the like, and a release layer such as fluororesin, and the heating roller 610 is rotatably supported and conveys a paper sheet S. An outer diameter and a length in the axial direction of the pressure roller 640 are about the same as those of the heating roller 610.

The pressure roller 640 is biased toward the pad 620 with a predetermined pressure. While pressing a part of the fixing belt 630 stretched around the pad 620 and being rotated and driven by a motor (not illustrated), the pressure roller 640 drives the fixing belt 630 by a frictional force.

The pressure adjuster 650 changes a relative positional relation between the pressure roller 640 and the pad 620 so as to change a pressing force between the pad 620 and the pressure roller 640 and change a pressure at the fixing nip 660 or a pressure distribution. Specifically, the pressure adjuster 650 includes a slider, for example, driven by a motor and can change a relative position of the pressure roller 640 relative to the pad 620 by sliding the pressure roller 640 relative to a main body of the fixer 600.

In the present embodiment, in a case where a toner layer of the toner image includes crystalline polyester resin, a pressing force with which the pad 620 is pressed by the pressure roller 640 is set to be the maximum on an inlet side of the fixing nip 660 in the sheet passing direction. As a result, gloss of the fixed toner image is increased (enhanced). The reason why the gloss of the fixed toner image is increased will be described later.

<Operation Display 700>

The operation display 700 receives an instruction of a user and displays a message to the user on a screen. In the present embodiment, the operation display 700 includes a keyboard and a touch panel. The user inputs an instruction to the image forming device 100 by operating the keyboard and the screen displayed on the touch panel. Furthermore, input information, various setting information, and a warning message, and the like are displayed on the screen.

<Communicator 800>

The communicator 800 is an interface for communicating with a device such as a client terminal connected to a network. The communicator 800 receives a print job from the client terminal and transmits the received job to the image processor 300.

<Controller 900>

The controller 900 integrally controls components including the image reader 200, the image processor 300, the image former 400, the sheet feeding conveyer 500, the fixer 600, the operation display 700, and the communicator 800 and realizes functions of the image forming device 100.

The controller 900 includes a memory, a hard disk drive, and a central processing unit (CPU) which are not illustrated and are mutually connected with an internal bus.

The memory includes a Random Access Memory (RAM) and a Read Only Memory (ROM) and stores the print image data generated by the image processor 300, various processing results, various parameters, and the like.

The hard disk drive stores an operating system, various application programs, a control program for controlling each part of the image forming device 100, and the like. The CPU realizes various functions by executing the control program.

The controller 900 sets a pressing force between the pad 620 and the pressure roller 640 based on the instruction of the user. More specifically, pressing forces to the pad 620 (referred to as “pad surface pressure” below) on the fixing nip 660 at different positions in the sheet passing direction are input and stored in the memory or the hard disk drive. The value of the pressing force may be stored in the hard disk drive or the ROM of the memory in advance at the time of shipment of a product. Furthermore, the user may set or change the value of the pressing force via the operation display 700. The pressure adjuster 650 drives a motor of the slider according to the value of the pressing force set by the controller 900 and slides the pressure roller 640.

<Setting of Pad Surface Pressure>

The inventor of the present invention has found that gloss of an image fixed on the paper sheet 102 is increased by setting the pad surface pressure on the fixing nip 660 to be large on the inlet side with respect to the sheet passing direction and to be small on the outlet side.

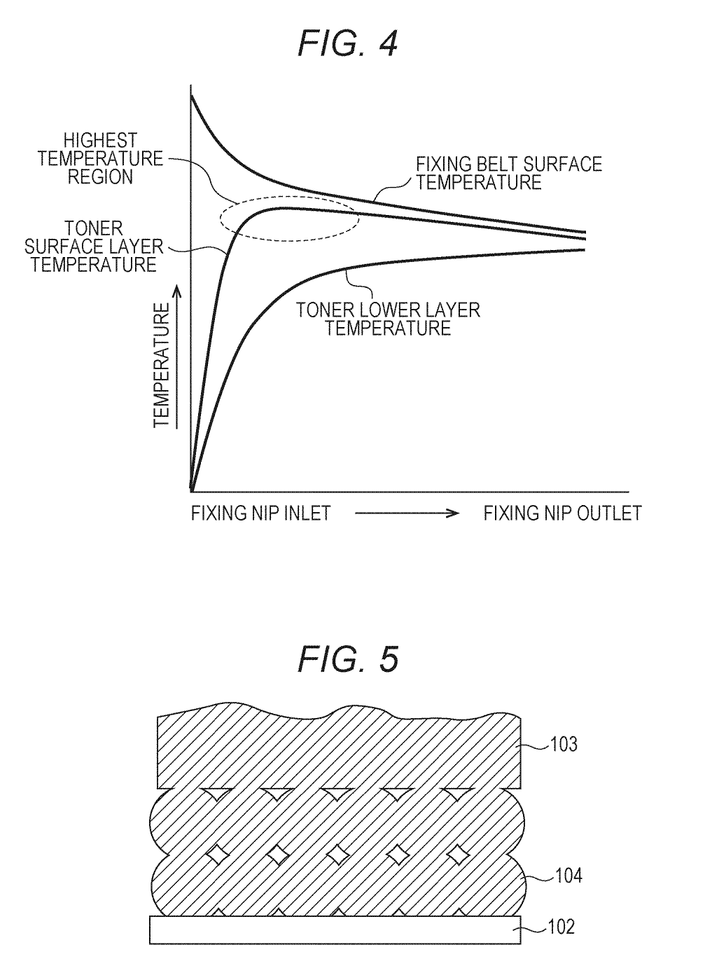

Hereinafter, with reference to FIG. 4 and FIG. 5, a reason why the gloss of the image fixed on the paper sheet 102 is increased in the present embodiment will be described. FIG. 4 is a graph of a temperature change of the fixing belt 630 in the sheet passing direction of the fixing nip 660 and a temperature change of a toner layer in the sheet passing direction of the paper sheet 102 passed through the fixing nip 660. FIG. 5 is a schematic diagram of a modeled melted state of the toner layer accompanied by heat and pressure according to the present embodiment.

As illustrated in FIG. 4, since the fixing belt 630 is heated by the heater lamp 611 which is a heating source, a surface temperature of the fixing belt 630 at the inlet of the fixing nip 660 is high. However, after that, the fixing belt 630 has contact with the paper sheet 102, and the heat is supplied from the fixing belt 630 to the toner layer of the paper sheet 102. Therefore, the surface temperature of the fixing belt 630 is gradually lowered as the paper sheet 102 travels toward the outlet of the fixing nip 660.

In addition, the heater lamp 611 and the fixing nip 660 are arranged at a distance from each other, and the heat generated by the heater lamp 611 is transmitted to the fixing nip 660 via the fixing belt 630. Since the heat generated by the heater lamp 611 is partially radiated into the environment while moving in the fixing belt 630, the heat is not sufficiently supplied to the fixing nip 660, and the surface temperature of the fixing belt 630 is lowered.

When the toner layer is divided into a toner surface layer (referred to as “surface layer” below) and a toner lower layer, that is, a layer in the vicinity of the paper sheet (referred to as “lower layer” below), temperatures of the surface layer and the lower layer are as follows.

When the paper sheet 102 reaches the fixing nip 660 and has contact with the fixing belt 630, heat is supplied from the fixing belt 630 to the toner layer on the paper sheet 102. Therefore, the temperature of the surface layer is sharply increased. After that, since the surface temperature of the fixing belt 630 is lowered as the paper sheet 102 travels toward the direction of the outlet of the fixing nip 660, the temperature of the surface layer is lowered. The temperature of the surface layer is the highest at the inlet of the fixing nip 660.

On the other hand, since it takes time to transmit the heat supplied from the fixing belt 630 to the lower layer, the temperature of the lower layer is gently increased in comparison with the temperature of the surface layer.

In this way, since the temperature of the surface layer becomes the highest at the inlet of the fixing nip 660, when a large pressing force is applied to the pad 620 near the inlet of the fixing nip 660, the lower layer does not melt, and the surface layer melts. That is, melting degrees of the toner vary in a thickness direction of the toner layer.

For example, as illustrated in FIG. 5, in the vicinity of the inlet of the fixing nip 660, a temperature of a surface layer 103 is increased by the heat supplied from the fixing belt 630, and the surface layer 103 melts. On the other hand, a temperature of a lower layer 104 is low until the heat from the surface layer 103 is sufficiently transmitted, and the lower layer 104 does not melt. By applying the large pressing force to the pad 620 in the vicinity of the inlet of the fixing nip 660, the surface layer 103 is efficiently flattened. Therefore, the gloss of the image fixed on the paper sheet 102 is enhanced (increased).

Thereafter, the heat of the surface layer 103 is transferred to the lower layer 104, and the lower layer 104 starts to melt. As a result, the lower layer 104 is melted at least until fixing of the lower layer 104 to the paper sheet 102 is secured. Therefore, in the present embodiment, the image of which the gloss is enhanced can be obtained, and the toner is sufficiently fixed to the paper sheet 102.

On the other hand, when a large pressing force is applied to the pad 620 at a position where the temperature of the surface layer 103 is lowered without applying a large pressing force to the pad 620 in the vicinity of the inlet of the fixing nip 660, the gloss of the fixed image is weakened. Therefore, by changing the position where the large pressing force is applied to the pad 620 (referred to as “pressure peak position” below) as necessary, the strength of the gloss of the fixed image can be controlled.

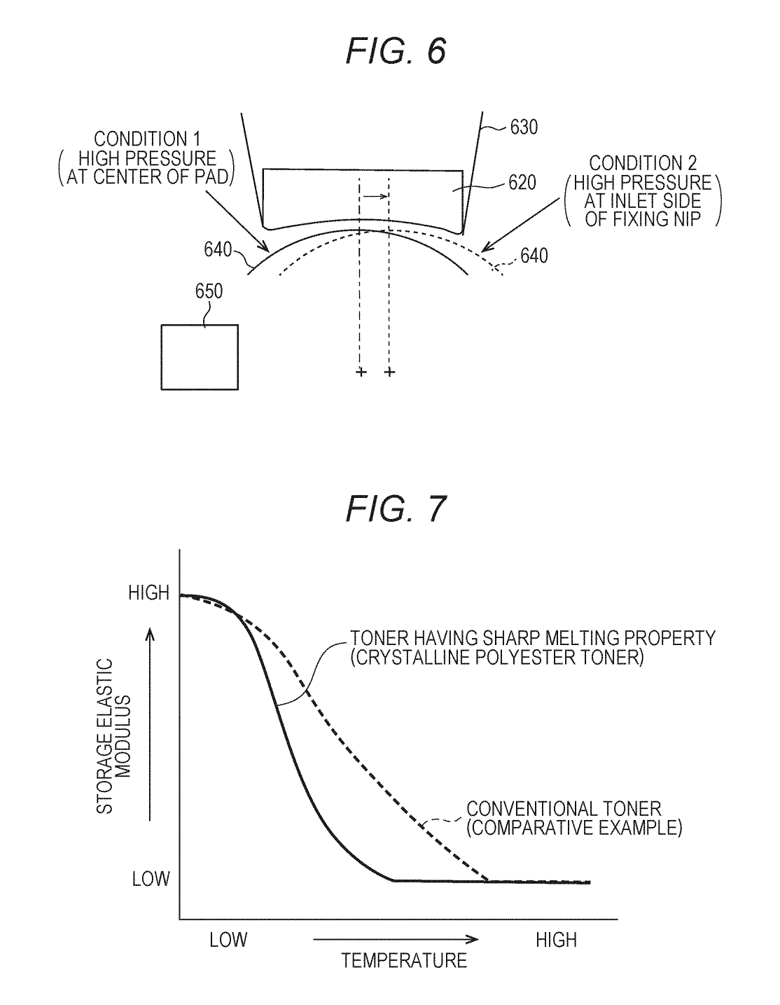

FIG. 6 is a schematic diagram of an example of a case where a position of the pressure roller 640 relative to the pad 620 in the sheet passing direction is changed. As illustrated in FIG. 6, normally, the pressure adjuster 650 sets the position of the pressure roller 640 to a position in a condition 1. At the position in the condition 1, the pressure peak position in the pressure distribution to the pad 620 is set to the vicinity of the center of the pad 620. On the other hand, in a case where the gloss of the image is enhanced, the pressure adjuster 650 moves the position of the pressure roller 640 to a position in a condition 2. At the position in the condition 2, the pressure peak position in the pressure distribution to the pad 620 is set to the inlet of the fixing nip 660.

FIG. 6 indicates an example of a case where a position of the pressure roller 640 relative to the pad 620 in the sheet passing direction is changed. Specifically, the position is shifted by a predetermined distance in a direction parallel to the paper sheet conveyance direction. However, the present embodiment is not limited to such an example. Instead of changing the position of the pressure roller 640, the position of the pad 620 relative to the pressure roller 640 may be moved.

<Toner>

In the present embodiment, it is desirable to use a toner having a sharp melting property (referred to as “sharp melt toner” below). The sharp melt toner rapidly melts at a temperature in a narrow range. Therefore, in the toner layer, the lower layer does not melt, and the surface layer is efficiently melted.

FIG. 7 is a diagram of temperature characteristics of storage elastic modulus of a toner used in the present embodiment and a conventionally used toner (conventional toner as comparative example). In the present embodiment, the toner including crystalline polyester resin having storage elastic modulus which is equal to or higher than 1.0×10⁸ (Pa) at a low temperature of 30° C. and is equal to or lower than 1.0×10⁵ (Pa) at a high temperature of 80° C. is used. As a result, the surface layer is rapidly and selectively melted in a short time, and the image with the enhanced gloss is fixed.

The sharp melt toner (crystalline polyester toner) and the conventional toner have the following composition.

The sharp melt toner uses styrene-acrylic resin (copolymer of styrene/butyl acrylate/methacrylic acid) and styrene-acrylic modified crystalline polyester (crystalline polyester is condensate of dicarboxylic acid and dialcohol) for core resin and uses styrene-acrylic modified non-crystalline polyester (non-crystalline polyester is condensate of terephthalic acid, fumaric acid, and bisphenol A alkylene oxide adduct) for shell resin.

The conventional toner uses styrene-acrylic (copolymer of styrene/butyl acrylate/methacrylic acid) for core resin and uses styrene-acrylic modified non-crystalline polyester (non-crystalline polyester is condensate of terephthalic acid, fumaric acid, and bisphenol A alkylene oxide adduct) for core resin and shell resin.

<Modification>

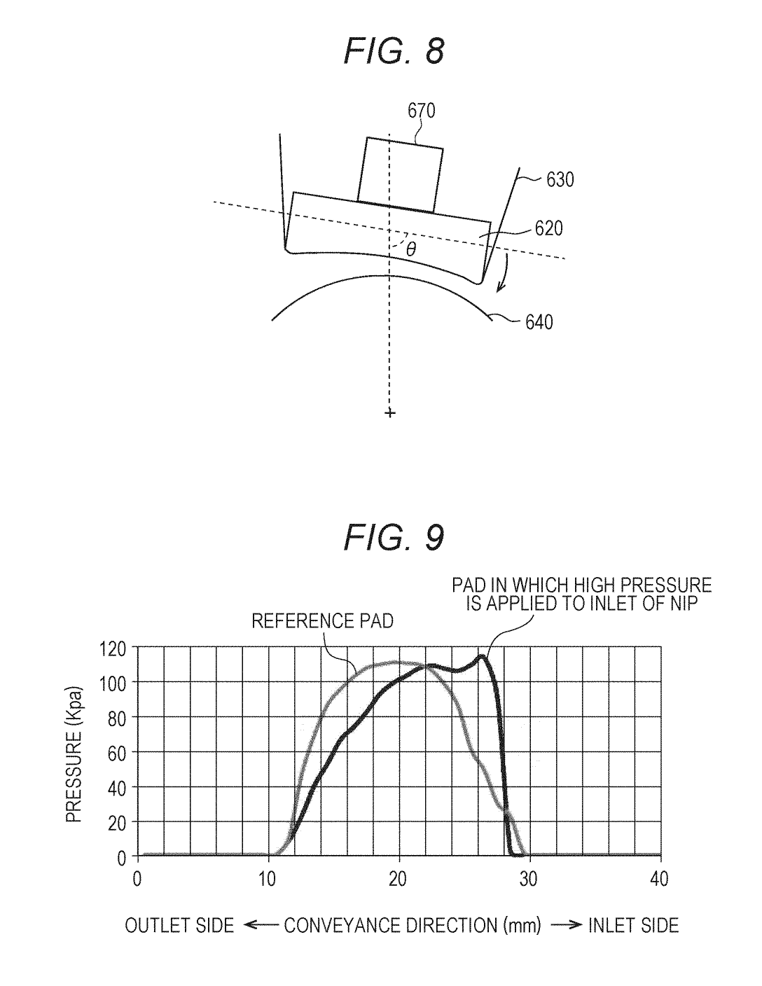

FIG. 8 is a schematic diagram of a modification according to the present embodiment. As illustrated in FIG. 8, a pressure adjuster 670 changes an attitude of the pad 620 relative to the pressure roller 640, that is, an inclination of the pad 620 so as to change a pressure with which the pad 620 is pressed by the pressure roller 640.

More specifically, with respect to the arrangement state illustrated in FIG. 3, the pad 620 is inclined so that a higher pressure is applied to the inlet side. For example, the inclination of the pad 620 relative to a perpendicular is set so that the perpendicular extending from the center of the pressure roller 640 toward the pad 620 intersects with a plane including the pad 620 at an acute angle θ at the inlet side of the fixing nip 660. That is, if the inclination θ of the pad 620 is less than 90°, when the pad 620 and the pressure roller 640 form the fixing nip 660, the pressure at the inlet side is higher than the pressures at the center and the outlet side. By setting the inclination of the pad 620 in this way, the pressure peak position is set to the inlet side of the fixing nip 660.

### Example

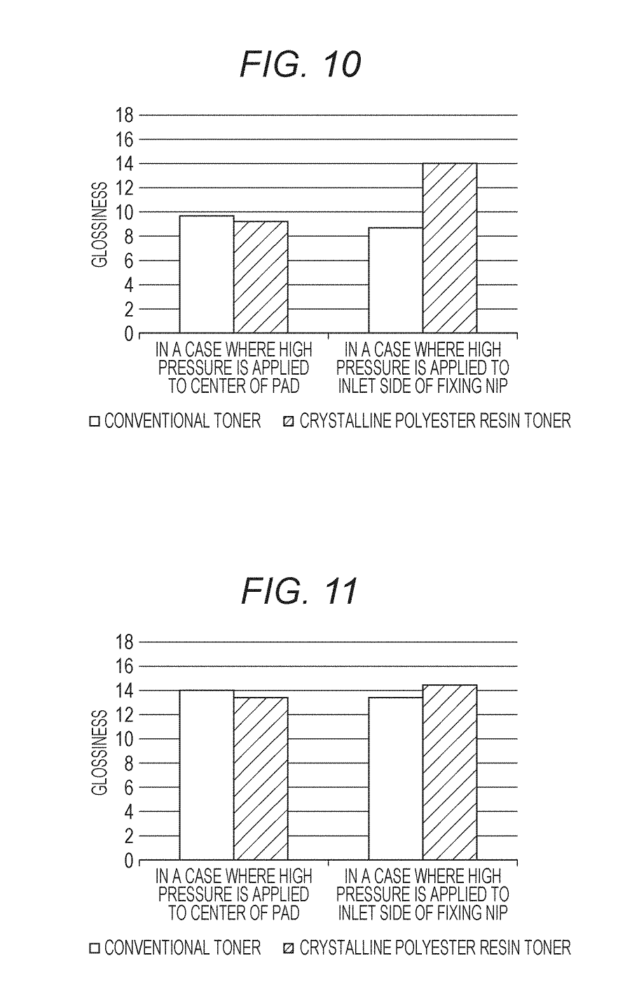

FIG. 9 is a graph of conditions of the pressure distribution with respect to the pad, and FIG. 10 is a graph of results of a comparative experiment (system speed: 415 mm/s) for exemplifying a difference in glossiness due to a difference in a position to which pressure is applied. FIG. 11 is a graph of results of a comparative experiment (system speed: 300 mm/s) for exemplifying a difference in glossiness due to a difference in a position to which pressure is applied.

A comparative experiment is conducted regarding a case where the pressure peak position is set at the inlet of the fixing nip and a case where the pressure peak position is set at the center of the pad. The conditions in an experiment 1 according to the example will be described below.
Heating roller: diameter φ40, rubber layer: thickness t1 (1 mm),
Fixing belt: diameter φ80, belt base material: polyimide (PI), thickness 70 μm, belt rubber layer: silicone rubber, thickness 200 μm
Pressure roller: diameter φ50, rubber layer: sponge rubber, thickness t5 (5 mm),
Fixing nip width: 18 mm

The conditions in the pressure distribution are determined as follows. The pressing force applied to the pad is changed by changing the shape of the pad. Specifically, a pad (reference pad) which is symmetrical about the center part in the sheet passing direction is compared with a pad of which a thickness on the inlet side of the fixing nip in the sheet passing direction is increased.

In the present example, measurement is performed as sandwiching a sensor sheet in the fixing nip by using an inter-roller pressure distribution measuring system manufactured by NITTA Corporation. In the sensor sheet, first electrodes of M rows and second electrodes of N rows arranged apart from the first electrodes form a matrix. Surfaces of the first electrodes and the second electrodes are coated with pressure-sensitive conducting ink, and when the sensor sheet is pressed, an electric resistance value at the intersection between the first electrode and the second electrode in the pressed part changes. The inter-roller pressure distribution measuring system calculates a pressure distribution between the rollers based on electric resistance values of a plurality of pressed parts on the sensor sheet.

A comparative experiment has been conducted regarding the toner formed of crystalline polyester resin and the conventional toner. A solid toner image to which a black toner of four g/m² is attached is formed on a POD coated paper (128 g/m²), and the toner image is fixed with the above pressure distribution as passing through the POD paper at a fixing temperature of 185° C. and at a system speed (paper sheet conveyance speed) of 415 mm/s, and glossiness is measured by a glossmeter (60°). Note that, to secure the fixing property, the fixing temperature of the conventional toner is set to be higher by about eight ° C.

As a result, as illustrated in FIG. 10, by using the conventional toner, a difference in glossiness according to the position of the surface peak has hardly been found. The difference in the gloss of the image and the gloss of the paper sheet around the image has caused uncomfortable feeling. On the other hand, with the toner formed of crystalline polyester resin, in a case where the pressure peak position has been set at the inlet of the fixing nip, the glossiness has been increased by about five degrees than a case where the pressure peak position has been set at the center. As a result, the uncomfortable feeling caused between the image and the paper sheet around the image is reduced.

In addition, by slowing the system speed than the above comparative experiment, a comparative experiment (experiment 2) is performed at the system speed of 300 mm/s. Note that conditions other than the system speed are the same as those of the experiment 1.

As illustrated in FIG. 11, in a case where the system speed is slow, heat is easily supplied from the pad to the toner on the paper sheet. Therefore, an effect of the shape of the nip, that is, the position of the surface pressure peak on the glossiness is small. Furthermore, in a case where the system speed is slower than 300 mm/s, the effect on the glossiness is further reduced. A difference in the glossiness of the image in a case where the pressure peak position is set to the center and the glossiness of the image in a case where the pressure peak position is set at the inlet of the fixing nip is extremely small.

Therefore, in consideration of the experiments 1 and 2, in a case of the high-speed system, to increase the surface pressure at the inlet of the fixing nip by using the sharp melt toner is effective for maintaining high glossiness. In the present embodiment, it is preferable that a paper sheet conveying speed be, for example, equal to or faster than 300 mm/s.

In this way, in a case where gloss paper with high gloss is used, by reducing a difference in the glossiness between the gloss of the paper sheet and the gloss of the image by enhancing the gloss of the image on the paper sheet, it is possible to prevent or reduce the uncomfortable feeling caused by the gloss of the image. More specifically, a decrease in the temperature of the inlet side of the fixing nip 660 caused by the contact between the paper sheet 102 with the fixing belt 630 is small, and the temperature is maintained to be high. Therefore, by making the pressing force applied to the pad 620 at the inlet side of the fixing nip 660 be higher than the other part of the fixing nip 660, the surface layer 103 efficiently melts, and an image with high gloss can be realized with low thermal energy.

Furthermore, by using the toner including crystalline polyester resin having a sharp melting property, the surface layer 103 can efficiently melt.

Although embodiments of the fixing device and the image forming device according to the present invention have been described and illustrated in detail, the disclosed embodiments are made for purposes of illustration and example only and not limitation. The scope of the present invention should be interpreted by terms of the appended claims. It goes without saying that those skilled in the art can appropriately make addition, modification, and omission to the present invention within the scope of the technical idea.

What is claimed is:

1. A fixing device that fixes a toner image formed on a paper sheet, the fixing device comprising:
an endless fixing belt;
a pressure roller that is rotatable; and
a pressing member that is arranged to face the pressure roller with the fixing belt interposed therebetween and forms a fixing nip for conveying a paper sheet between the pressing member and the pressure roller, wherein
a toner layer of the toner image includes crystalline polyester resin, and
a pressure distribution of the fixing nip in a sheet passing direction is set so that pressure at an inlet side in the sheet passing direction is the largest, and gloss of an image fixed on the paper sheet is enhanced.

2. The fixing device according to claim 1, wherein
a storage elastic modulus of the crystalline polyester resin is equal to or more than 1.0×10⁸ at 30° C. and is equal to or less than 1.0×10⁵ at 80° C.

3. The fixing device according to claim 1, wherein
a conveying speed of the paper sheet is equal to or faster than 300 mm/s.

4. The fixing device according to claim 1, further comprising:
a pressure adjuster that changes the pressure distribution with respect to the sheet passing direction of the fixing nip.

5. The fixing device according to claim 4, wherein
to enhance the gloss of the image fixed on the paper sheet, the pressure adjuster sets a pressing force between the pressing member and the pressure roller to be the largest at the inlet side of the fixing nip in the sheet passing direction by changing relative positional relation between the pressing member and the pressure roller or an attitude of the pressing member with respect to the pressure roller.

6. An image forming device comprising:
a hardware processor that forms a toner image on a paper sheet; and
the fixing device according to claim 1 that fixes the toner image formed by the hardware processor on the paper sheet.
